(19) United States
(12) Patent Application Publication
(10) Pub. No.: US 2009/0086464 A1
(43) Pub. Date: Apr. 2, 2009

(54) SHIFT LEVER POSITION INDICATOR

(75) Inventor: Tomohiro TAKAHIRA, Hamamatsu-shi (JP)

Correspondence Address: FOLEY AND LARDNER LLP;SUITE 500, 3000 K STREET NW, WASHINGTON, DC, 20007, US

(73) Assignee: FUJI KIMO CO., LTD.

(21) Appl. No.: 12/208,695

(22) Filed: Sep. 11, 2008

(30) Foreign Application Priority Data
Sep. 28, 2007 (JP) 2007-252934

(51) Int. Cl. G01D 11/28

(52) U.S. Cl. 362/30

(57) ABSTRACT

A shift lever position indicator includes a light transmission plate and a light source which illuminates the inside of the light transmission plate. The light transmission plate is formed by a single plate and has a character indicating portion which is provided on a bottom surface of the light transmission plate and indicates a shift lever position, a protruding portion which is provided in a position corresponding to the character indicating portion on a top surface of the light transmission plate and through which a light from an inside of the light transmission plate passes, and a reflection part which is set inside the light transmission plate so that an incoming light to the inside of the light transmission plate is irregularly reflected and further reflected by the character indicating portion then comes out of the light transmission plate from the protruding portion.

### BACKGROUND OF THE INVENTION

The present invention relates to a shift lever position indicator which is structured by a single light transmission plate.

In a vehicle, a shift lever is installed for shifting a transmission, and a shift lever position indicator that indicates a shift position selected by the shift lever is also installed. The shift lever position indicator is provided with characters such as “P”, “R”, “N”, “D”.

In recent years, there have been proposed and developed various shift lever position indicators. One such shift lever position indicator has been disclosed in Japanese Patent Provisional Publication No. 7-317889 (hereinafter is referred to as “JP7-317889”) that corresponds to U.S. Pat. No. 5,532,908. The shift lever position indicator in JP7-317889 has an indicator plate installed at a close position to the shift lever. The indicator plate has a two-layer structure having a character plate whose lower surface is provided with the characters such as “P”, “R”, “N”, “D”, and a light guiding plate (a light-transmissible plate) which is installed below the character plate and guides light of a light bulb to the character plate. The character plate is then illuminated from a lower direction by the light of the light bulb, and a driver can recognize or perceive the position of the shift lever by the light passing through the character plate.

### SUMMARY OF THE INVENTION

In JP7-317889, however, the indicator plate of the shift lever position indicator is structured by the two layers of the character plate and the light guiding plate. Because of this, the number of parts increases and manufacturing or assembling cost becomes higher. And besides, it takes longer time to assemble this two-layer structure.

It is therefore an object of the present invention to provide a shift lever position indicator which is structured by the single light transmission plate and is easily installable.

According to one aspect of the present invention, a shift lever position indicator comprises: a light transmission plate having a character indicating portion which is provided on a bottom surface of the light transmission plate and indicates a shift lever position; a protruding portion which is provided in a position corresponding to the character indicating portion on a top surface of the light transmission plate and through which a light from an inside of the light transmission plate passes; and a reflection part which is set inside the light transmission plate so that an incoming light to the inside of the light transmission plate is irregularly reflected and further reflected by the character indicating portion then comes out of the light transmission plate from the protruding portion; and a light source which illuminates the inside of the light transmission plate.

According to another aspect of the present invention, a method for indicating a shift lever position of a shift lever position indicator, wherein the shift lever position indicator includes a light transmission plate having a character indicating portion provided on a bottom surface of the light transmission plate; a protruding portion provided in a position corresponding to the character indicating portion on a top surface of the light transmission plate; a reflection part provided inside the light transmission plate, and a light source, the method comprises: illuminating an inside of the light transmission plate with the light source; irregularly reflecting an incoming light inside the light transmission plate by the reflection part; reflecting the irregularly reflected light again by the character indicating portion; and emitting the light reflected by the character indicating portion from the protruding portion.

The other objects and features of this invention will become understood from the following description with reference to the accompanying drawings.

### BRIEF DESCRIPTION OF THE DRAWINGS

FIG. 1A is a perspective view of a shift lever position indicator of a first embodiment. FIGS. 1B and 1C are sectional views explaining illumination and diffused reflection of light from a light source.

FIGS. 2A and 2B are a perspective view and a sectional view of a shift lever position indicator of a second embodiment.

FIG. 3 is a perspective view of an indicator panel.

### DETAILED DESCRIPTION OF THE INVENTION

Embodiments of the shift lever position indicator will be explained below with reference to the drawings.

### First Embodiment

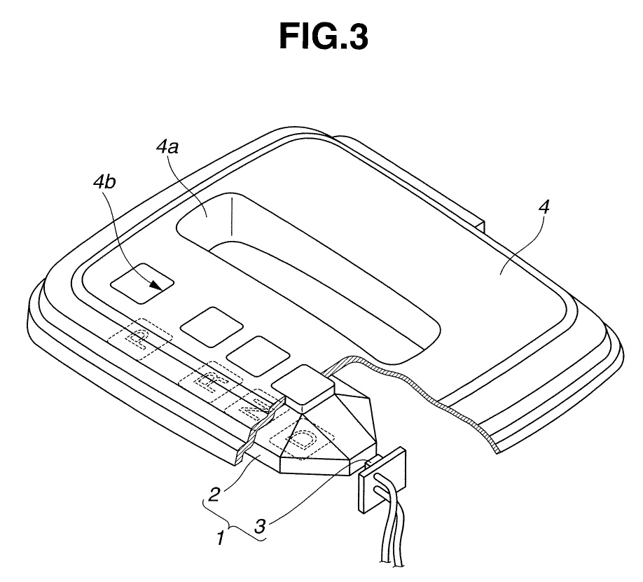

Now, a first embodiment will be explained. Firstly, as illustrated in FIG. 3, an indicator panel 4 is provided in a close position to a shift lever (not shown) in a vehicle. The indicator panel 4 has a long hole 4a and a plurality of windows 4b. The long hole 4a is formed to insert the shift lever therein. On the other hand, the each window 4b is formed to indicate a shift position of the shift lever.

A shift lever position indicator 1 of the first embodiment is installed under the indicator panel 4. The shift lever position indicator 1 has a light transmission plate 2 and an LED (Light-Emitting Diode) 3 that is positioned at one end surface of the light transmission plate 2 as a light source. The light transmission plate 2 is formed by for instance a transparent glass, a transparent resin or the like. In the present embodiment, the light transmission plate 2 is formed by a transparent acrylic resin.

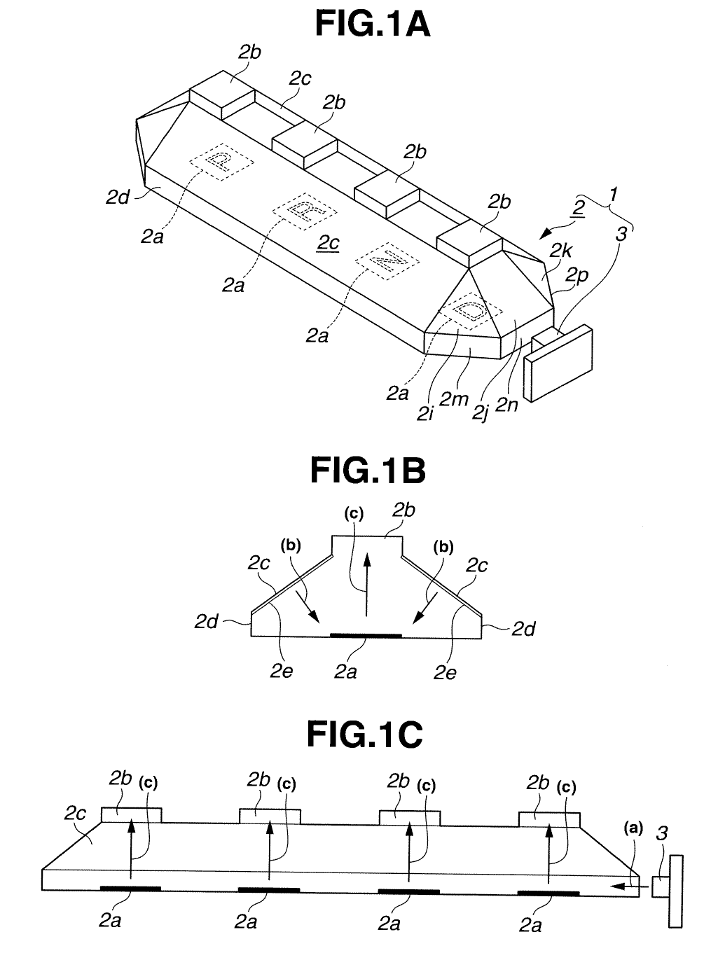

A structure of the shift lever position indicator 1 is shown in FIGS. 1A to 1C. A plurality of character indicating portions (simply, indicating portions) 2a that indicate the shift lever position are arranged on a bottom surface of the light transmission plate 2. These indicating portions 2a are provided with the respective characters “P”, “R”, “N”, “D”, and arranged in a straight line. On the other hand, a plurality of protruding portions 2b are formed on a top surface of the light transmission plate 2. More specifically, these protruding portions 2b are arranged at positions corresponding to the characters “P”, “R”, “N”, “D” of the indicating portions 2a, and are fitted into the windows 4b of the indicator panel 4 illustrated in FIG. 3. Size of the indicating portion 2a is set to the almost same size as a top surface of the protruding portion 2b. Further, an area except the indicating portion 2a, of the bottom surface of the light transmission plate 2 is colored in black etc.

As for the LED 3, as shown in FIGS. 1A, 1C and 3, it is set at an end portion of a longitudinal direction in which the indicating portions 2a of the light transmission plate 2 are arranged. The LED 3 then illuminates an inside of the light transmission plate 2 from the end portion toward the inside of the light transmission plate 2 in the longitudinal direction.

In the light transmission plate 2, reflection parts 2e are provided on both side surfaces of the light transmission plate 2. More specifically, the reflection parts 2e are set so that light illuminated from the LED 3 along the longitudinal direction of the light transmission plate 2 is irregularly reflected inside the light transmission plate 2 and this irregularly reflected light (diffused reflection of light) comes out of the light transmission plate 2 from the protruding portions 2b. That is to say, as shown in FIG. 1B, downward inclined or sloping surfaces 2c, which slope in a downward direction and face the indicating portions 2a, and also vertical surfaces 2d are formed on the both sides of the light transmission plate 2, then the reflection part 2e is provided on the downward inclined surface 2c. The reason why the reflection part 2e is provided on the downward inclined surface 2c sloping in the downward direction is because it is possible that the irregularly reflected light by the reflection part 2e travels toward the indicating portion 2a and the light reflected again by the indicating portion 2a comes out of the light transmission plate 2 from the protruding portions 2b.

The reflection part 2e is provided with a granular or sandy surface having microscopic or fine asperities. Then, as illustrated in FIGS. 1B and 1C, light (a) illuminated along the longitudinal direction of the light transmission plate 2 is irregularly reflected by the reflection part 2e and this reflected light (b) illuminates the whole indicating portion 2a.

In the present embodiment, in addition to the downward inclined surface 2c and the vertical surface 2d, as shown in FIG. 1A, downward inclined surfaces 2i, 2j and 2k and vertical surfaces 2m, 2n and 2p are formed at both sides of the longitudinal direction of the light transmission plate 2.

Next, an indicating function or operation of the shift lever position indicator will be explained.

As illustrated in FIGS. 1C and 1B, when the light (a) is illuminated along the longitudinal direction of the light transmission plate 2 by the LED 3, the light (a) is irregularly reflected by the reflection part 2e of the downward inclined surface 2c facing the indicating portion 2a. This irregularly reflected light (b) travels toward the indicating portion 2a and the light (b) is reflected again by the indicating portion 2a, as mentioned above. Then, this light (c) reflected by the indicating portion 2a comes out of the light transmission plate 2 from the protruding portions 2b. With this indicating function, a driver can recognize or perceive the whole of the indicating portion 2a through the sight.

### Second Embodiment

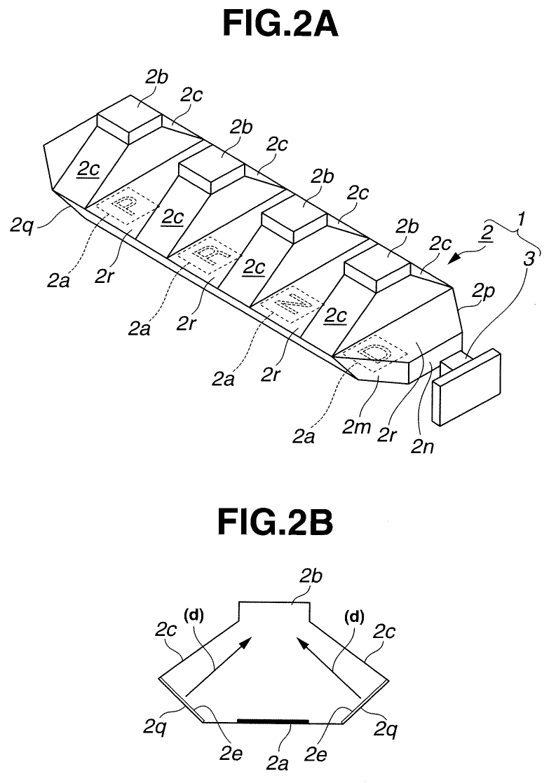

Next, a second embodiment will be explained with reference to FIGS. 2A and 2B. The light transmission plate 2 of the second embodiment has a cross section shown in FIG. 2B. In the above first embodiment, the vertical surfaces 2d are formed on the both sides of the light transmission plate 2. However, in the second embodiment, upward inclined or sloping surfaces 2q that face the protruding portion 2b are formed instead of the vertical surfaces 2d. And further, the reflection part 2e is provided on this upward inclined surface 2q. The light transmission plate 2 of the second embodiment is structured so that the light irregularly reflected by the reflection part 2e directly comes out of the light transmission plate 2 from the protruding portions 2b. With regard to the structure of the reflection part 2e, it is the same as that of the first embodiment. That is, the reflection part 2e is provided with the granular or sandy surface having the microscopic or fine asperities.

In this embodiment, unlike the first embodiment, the downward inclined surface 2c located above the upward inclined surface 2q is not formed throughout the length of the light transmission plate 2. As can be seen in FIG. 2A, horizontal surfaces 2r are formed between the protruding portions 2b, and the downward inclined surfaces 2c are formed only in positions corresponding to the protruding portions 2b. However, the inclined surfaces 2c could be formed throughout the length of the light transmission plate 2, same as the first embodiment.

The indicating function or operation of the shift lever position indicator of the second embodiment will be explained. When the light (a) is illuminated along the longitudinal direction of the light transmission plate 2 by the LED 3 in the same manner as FIG. 1C, the light (a) is irregularly reflected by the reflection part 2e of the upward inclined surface 2q. This irregularly reflected light (d) directly comes out of the light transmission plate 2 from the protruding portions 2b, as shown in FIG. 2B. On the other hand, a part of the light irregularly reflected by the reflection part 2e of the upward inclined surface 2q travels toward the indicating portion 2a and illuminates the indicating portion 2a, and further comes out of the light transmission plate 2 from the protruding portions 2b by being reflected by the indicating portion 2a. With this indicating function, the characters are indicated as if the characters floated or stood out, and look fine.

In the above first and second embodiments, the LED is used as the light source. However, it could be a light bulb. Further, the LED 3 is set at the one end surface of the light transmission plate 2. However, the LEDs 3 could be set at both side surfaces of the light transmission plate 2. Moreover, as shown in FIG. 1A, although the downward inclined surface 2c having the reflection part 2e is formed throughout the length of the light transmission plate 2, the downward inclined surface 2c might be separately formed only in a position corresponding to the indicating portion 2a.

Next, effects of the present invention will be described. In the present invention, the shift lever position indicator employs a very simple structure using the single light transmission plate. Therefore, as compared with the related art shift lever position indicator employing the two-layer structure having the character plate and the light guiding plate, the number of parts can be reduced and the manufacturing or assembling cost becomes lower. And besides, the shift lever position indicator is easily installable.

In addition, the shift lever position indicator does not employ a structure in which the light passes through the indicating portion, but employs the structure in which the light is reflected by the indicating portion. Therefore, the driver can recognize or perceive the position of the shift lever visually and clearly by this reflected light. Furthermore, since color of the light, which is suitable for easy recognition, can be easily used in the shift lever position indicator, the driver can recognize the position of the shift lever more clearly. Moreover, the shift lever position indicator can indicate the characters with a three-dimensional appearance, then looks fine.

Further, in the present invention, since the inside of the light transmission plate is illuminated by the light source, not only the characters but also the whole indicating portion are illuminated. Thus, the driver can easily recognize the shift lever position.

This application is based on a prior Japanese Patent Application No. 2007-252934 filed on Sep. 28, 2007. The entire contents of this Japanese Patent Application No. 2007-252934 are hereby incorporated by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A shift lever position indicator comprising:
a light transmission plate having
a character indicating portion which is provided on a bottom surface of the light transmission plate and indicates a shift lever position;
a protruding portion which is provided in a position corresponding to the character indicating portion on a top surface of the light transmission plate and through which a light from an inside of the light transmission plate passes; and
a reflection part which is set inside the light transmission plate so that an incoming light to the inside of the light transmission plate is irregularly reflected and further reflected by the character indicating portion then comes out of the light transmission plate from the protruding portion; and
a light source which illuminates the inside of the light transmission plate.

2. The shift lever position indicator as claimed in claim 1, wherein:
the reflection part is formed on a surface that faces the character indicating portion inside the light transmission plate so that the light irregularly reflected by the reflection part travels toward the character indicating portion and further reflected by the character indicating portion then comes out of the light transmission plate from the protruding portion.

3. The shift lever position indicator as claimed in claim 1, wherein:
the reflection part is formed on a surface that faces the protruding portion inside the light transmission plate so that the light irregularly reflected by the reflection part directly comes out of the light transmission plate from the protruding portion, while a part of the irregularly reflected light is reflected again by the character indicating portion then comes out of the light transmission plate from the protruding portion.

4. The shift lever position indicator as claimed in claim 1, wherein:
the light source is set at either one of both ends of a longitudinal direction of the light transmission plate, and illuminates the inside of the light transmission plate in the longitudinal direction.

5. The shift lever position indicator as claimed in claim 1, wherein:
the shift lever position indicator is installed inside an indicator panel, and
the protruding portion is shaped so that the protruding portion can be fitted into a window that is provided in the indicator panel for indicating the shift lever position.

6. A method for indicating a shift lever position of a shift lever position indicator, wherein the shift lever position indicator includes
a light transmission plate having
a character indicating portion provided on a bottom surface of the light transmission plate;
a protruding portion provided in a position corresponding to the character indicating portion on a top surface of the light transmission plate;
a reflection part provided inside the light transmission plate, and
a light source,
the method comprising:
illuminating an inside of the light transmission plate with the light source;
irregularly reflecting an incoming light inside the light transmission plate by the reflection part;
reflecting the irregularly reflected light again by the character indicating portion; and
emitting the light reflected by the character indicating portion from the protruding portion.

7. The method for indicating a shift lever position of the shift lever position indicator as claimed in claim 6, wherein:
the reflection part is formed on a surface that faces the character indicating portion inside the light transmission plate so that the light irregularly reflected by the reflection part travels toward the character indicating portion and further reflected by the character indicating portion then comes out of the light transmission plate from the protruding portion.

8. The method for indicating a shift lever position of the shift lever position indicator as claimed in claim 6, wherein:
the reflection part is formed on a surface that faces the protruding portion inside the light transmission plate so that the light irregularly reflected by the reflection part directly comes out of the light transmission plate from the protruding portion, while a part of the irregularly reflected light is reflected again by the character indicating portion then comes out of the light transmission plate from the protruding portion.
